(19) United States
(12) Patent Application Publication
(10) Pub. No.: US 2008/0103850 A1
(43) Pub. Date: May 1, 2008

(54) System And Method For Collecting Advertisement Information And For Real-Time Analyzing

(75) Inventor: Wei Shen, Beijing (CN)

Correspondence Address: AKERMAN SENTERFITT, P.O. BOX 3188, WEST PALM BEACH, FL, 33402-3188, US

(73) Assignee: Gmedia Corporation, George Town (KY)

(21) Appl. No.: 11/718,997

(22) PCT Filed: Oct. 28, 2005
(86) PCT No.: PCT/CN05/01780

§ 371 Date: May 10, 2007

(30) Foreign Application Priority Data
Nov. 10, 2004 (CN) 200410009771.3

(51) Int. Cl. G06Q 10/00; G01S 5/00; G06Q 30/00

(52) U.S. Cl. 705/7; 342/357.07

(57) ABSTRACT

The present invention discloses a system for collecting advertisement information and for analyzing, the system comprising: an information carrier for carrying advertising information, for example, advertising media, advertising territory, advertiser, related contents or index of the advertising and the like; a writing apparatus for performing information compiling and generating of the information carrier; a reading apparatus for reading the information on the information carrier; a mobile terminal for receiving and transmitting information through a network, the mobile terminal having the reading apparatus, an apparatus for acquiring location information of the mobile terminal, and an apparatus for acquiring the time when the mobile terminal sends the advertising information. The information carrier in this invention can be compiled and generated according to different media, regions, advertisement contents and advertisers, and can be conditionally combined with the location information of the mobile phone and the time information of sending, and therefore makes the advertising monitoring and analyzing more real-time, comprehensive and accurate.

### TECHNICAL FIELD

The present invention relates to a system and a method for monitoring advertising and performing real-time analysis thereon by using mobile terminals (particularly mobile phones) and a network.

### BACKGROUND ARTS

Recently, Internet has been widely used, and accessing Internet through a mobile phone is also popularized gradually. People may enjoy a variety of services through Internet, such as shopping, booking hotels, browsing information. Meanwhile, papers, magazines and posters are publishing more and more advertisements with URLs to direct people to access related web pages and acquire more information.

However, to access a network, a user has to perform operations such as inputting URLs on a terminal device and so on. For a mobile phone user, such complicated operations for accessing the network are quite cumbersome. However, for a computer terminal which is relatively convenient for the operation of inputting the URLs, it is often the case that the user does not take along the computer terminal when he is reading the advertisements. Therefore, this would impact the effect of advertising and promoting using URLs.

So far, advertisers have been evaluating and analyzing advertising effects (especially for printed advertisements) primarily by means of telephone feedbacks, sales statistics, questionnaire surveys, which typically get results several days and even several weeks after the advertisements are distributed, and can hardly give out real time, dynamic and continuous analysis reports.

The patent document [publication number] CN 1433621A discloses an interactive directly-responding system for enabling advertisers to observe the direct responses of consumers to advertising activities through a text short message system (SMS) used by a mobile phone in combination with a database and a network. A consumer is invited to take part in sending a message (i.e., a word) associated with a particular advertisement to respond to a separate telephone number related to a website through a defined advertisement distributed for example by a bulletin board. A computer receives and analyzes the information, and sends to the user an acknowledgement to the received information. In the system based on text short message, the user have to enter a short message interface and input characters or numbers according to the prompts of the advertisement, so it is somewhat inconvenient to use. At the same time, the phone number of the user will be revealed to the service provider as he sending out short messages, such that the user may be worried about his privacy. Considering relatively convenient operation for user, the texts sent by means of short message may not be too long, so as not be able to carry more advertising information such as advertiser, product, distributing media, region and the like, and consequently impact the analysis of advertising effect.

The patent document [publication Number] CN 1503176A discloses a product information providing system, in which, a user inputs his/her general information using a mobile phone, and sends the general user information and the information of the product he/she holds through the network; the system receives the information, performs an analysis on the user information and sends appropriate product information to the user. The system may also perform a market analysis on the products, and send the results to the advertisers. The main drawback of the system is that the users need to register and provide personal information, and the service provider needs to pay the registered users. Therefore, what the system addresses is the problem of real-time product investigation. This patent application discloses a product reading apparatus for reading product information from product information carriers fixed on products. The product information carriers, for example, product barcodes are originally on the products, so only the inherent information of the products can be read. Since monitoring of advertising requires compiling/generating information for information carriers (for example, generating barcode information), the system can not be used in advertising monitoring and analyzing. The product information carrier in this document is taken along by the product itself, and can not be self-generated.

The patent document [publication Number] CN 1363065A discloses an information collecting system capable of acquiring information through a network by accessing the network, which comprises a pointer sending apparatus (non-contact IC card) for sending out pointers of information acquired from the network, a portable terminal having an accessing apparatus to the network and an accessing apparatus to the pointer sending apparatus; and an information providing apparatus for providing information via the network. The system is characterized in that the portable terminal uses a pointer acquired by sending a request to the pointer sending apparatus, to acquire information from the information providing apparatus. The non-contact IC card is stuck to advertising media to facilitate the reading of the portable terminal and acquiring advertising information from the advertising server. The system also provides evaluating on the advertising effect. The drawback of the system is that the non-contact IC card is costly, and needs to be stuck to advertising media one by one, so it is not suitable for advertising by newspapers and magazines which typically have large circulation, but just suitable for outdoor advertising, for example, on subway cars. Meanwhile, a user has to externally connect a reading apparatus to the mobile phone to read the non-contact IC card, which will increase user's cost and inconvenience for carrying and operating.

### SUMMARY OF THE INVENTION

With respect to the drawbacks mentioned above, the present invention provides a system for collecting advertisement information and for real-time analyzing, which has easy access to network, and is applicable to more kinds of media and inexpensive in cost, and is able to record time information of sending and location information of a mobile terminal, to achieve the objective of being able to render real-time, dynamic and continuous analysis reports.

To achieve this objective, the present invention utilizes a technical solution as follows: a system for collecting advertisement information and for real-time analyzing, which comprises:

an information carrier for carrying advertising information such as advertising media, advertising region, advertiser, advertisement-related content or index and so on, wherein the information carrier is formed of encodable and automatically identifiable image such as barcode, and the carrying medium of the information carrier is a medium such as paper, plastic, chinaware, wood, CRT, LCD, PDP, outdoor display and so on;

a writing apparatus for compiling/generating the advertising information of the information carrier;

a reading apparatus for reading the advertising information on the information carrier, wherein the reading apparatus for reading the advertising information is an apparatus such as barcode reading apparatus that is installed on or wirelessly connected to the mobile terminal, and the reading apparatus for reading the advertising information may be a mobile telephone or a PDA with photographic function;

a mobile terminal for sending and receiving information via a network, the mobile terminal being equipped with the reading apparatus, an apparatus for acquiring location information of the mobile terminal, and an apparatus for acquiring the time at which the mobile terminal sends the advertising information;

wherein the advertising information is written into the information carrier by the writing apparatus, and then is read by the reading apparatus on the mobile terminal, and the advertising information being sent to an advertising server together with the time information and the location information of the mobile terminal reading the advertising information,

The advertising server, which comprises a storing apparatus for storing the advertising information, the advertisement content, as well as the location information and the sending time information of the mobile terminal; an analyzing apparatus for performing statistics and analysis on the advertising information, the location information and the time information, and for sending the statistic and analysis result to the advertiser terminal according to a request of the advertiser terminal; and a matching apparatus for conditionally combining and matching the received advertising information, the location information and the time information to create one or more storage records in the server, and for sending the one or more storage records to the mobile terminal according to a request of the mobile terminal, wherein the advertising server further stores, monitors and analyzes a series of operations of the networked mobile terminal,

wherein the network connecting the mobile terminal and the advertising server may be a public network, a private network, a wireless local area network and so on, and the transmitting format between the mobile terminal and the advertising server may be in the form of URL, email, SMS, MMS, WAP and so on,

an advertiser terminal for receiving information and analyzing report from the advertising server, and for interacting with the advertising server.

The present invention may be widely used in real-time effect monitoring and dynamic market analyzing for printed advertisements, outdoor advertisements and the like. Because the mobile terminal (especially a mobile phone) is equipped with the location acquiring apparatus, the time acquiring apparatus and the reading apparatus for reading advertising information, the adverting monitoring and analyzing may be more real-time, comprehensive and accurate. Additionally, the information carrier (for example, a barcode) in the present invention is suitable for a variety of media, for example: paper, plastic, chinaware, wood, CRT, LCD, PDP, outdoor display and so on, so that the present invention can be widely applicable; the information carrier may be re-written with a large mount of information; meanwhile, the information carrier in the present invention may be compiled and generated according to different media, regions, advertisement contents, advertisers, and is conditionally combined with the location information and the time information of sending of the mobile phone.

### DESCRIPTION OF THE DRAWINGS

FIG. 1 is a block diagram representing a system for collecting advertisement information and for analyzing of the present invention.

FIG. 2 is a representation of barcode patterns in accordance with example 1 of the present invention.

FIG. 3 is a block diagram of a writing apparatus in accordance with example 1 of the present invention.

FIG. 4 is a block diagram of a location acquiring apparatus in accordance with example 1 of the present invention.

FIG. 5 is a block diagram of a time acquiring apparatus in accordance with example 1 of the present invention.

FIG. 6 is a flow chart of a system for collecting advertisement information and for analyzing in accordance with example 1 of the present invention.

FIG. 7 is an instance for advertising monitoring and analyzing according to example 1 of the present invention.

FIG. 8 is an instance of advertising analysis report with respect to media according to example 1 of the present invention.

FIG. 9 is an instance of advertising analysis report with respect to regions according to example 1 of the present invention.

FIG. 10 is an instance of advertising analysis report with respect to regions according to example 1 of the present invention.

FIG. 11 is an instance of advertising market competition analysis in accordance with example 1 of the present invention.

FIG. 12 is a systematic flow chart of example 2 of the present invention.

FIG. 13 is an instance of consumer behavior analysis in accordance with example 2 of the present invention.

FIG. 14 is a flow chart for matching consumer behavior patterns with advertisement contents according to example 2 of the present invention.

FIG. 15 is a block diagram of a writing apparatus in accordance with example 3 of the present invention.

FIG. 16 is a flow chart for matching advertising IDs with advertisement information combinations according to example 1 of the present invention.

### DETAILED EMBODIMENTS

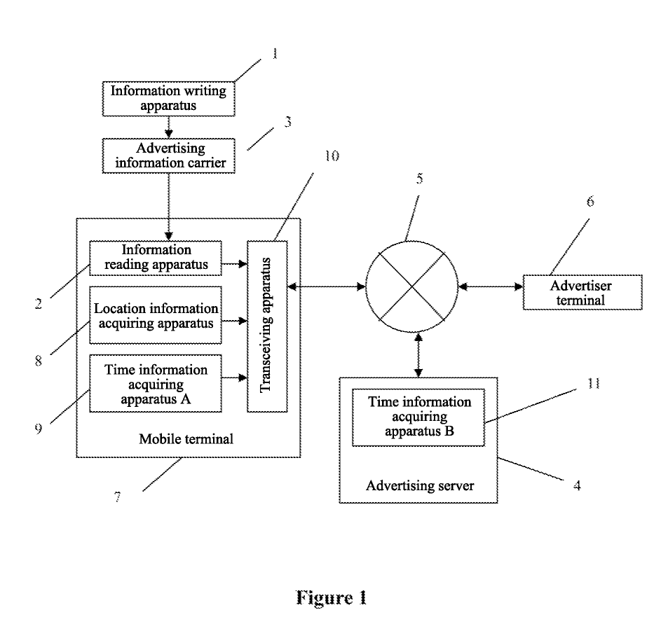

Referring to FIG. 1, a writing apparatus (1) writes advertising information into an information carrier (3), and then a reading apparatus (2) installed on or connected with a mobile terminal (7) reads the information carrier (3) affixed on an advertisement, wherein the information carrier may carry information such as advertising media, advertising region, advertiser, advertisement-related content or index and so on. A location acquiring apparatus (8) on the mobile terminal (7) may acquire location coordinate information of the mobile terminal according to user's demand or system triggering; a time acquiring apparatus A (9) on the mobile terminal (7) may acquire time information about when the advertising information is sent; or alternatively, a time acquiring apparatus B (11) is set in an advertising server (4), and may acquire time information about when the advertising information is received by reading the time information of the advertising server (4); the information on the information carrier is combined with the time and location information of the information carrier being read, and these kinds of information are partially or completely sent to the advertising server (4) by a transceiving apparatus (10) via a network (5). The advertising server stores, matches and analyzes the received information, and responds to the mobile terminal by, for example, transmitting an advertisement content through an URL, or transmitting an advertisement content associated with the location and the time of the mobile terminal user. The user's feedback to the advertisement content is also stored as analysis material in the advertising server. The advertising server performs analysis on advertisings and consumers, by using the received information from the mobile terminal, and sending the analysis result to an advertiser terminal (6) in real time.

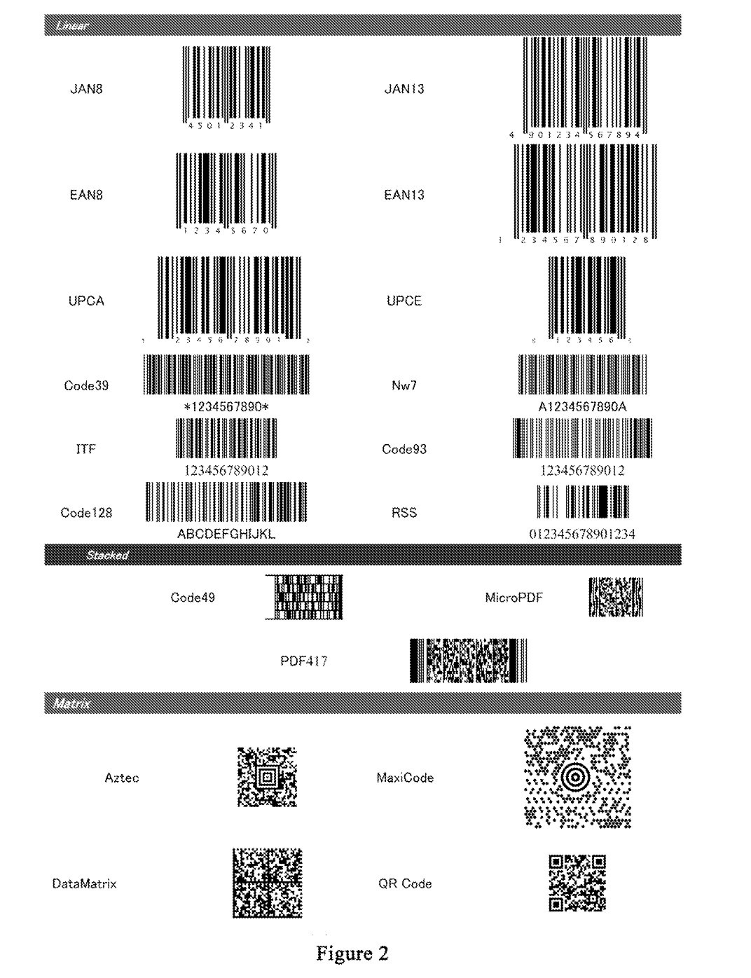

The information carrier is formed of encodable and automatically identifiable images, for example, one-dimensional barcode or two-dimensional barcode. Some exemplary patters of barcodes are shown in FIG. 2.

The writing apparatus is such an apparatus that encodes according to the advertising information such as advertising media, advertising region, advertiser and advertisement-related content or index, and writes the encoded information into the information carrier. This apparatus may be connected to printer, lithographic system, film outputting system, computer display, outdoor display, television and the like, so as to affix, lithograph, print, photocopy and display the compiled and generated information carrier (for example, barcode) on the advertisement.

The reading apparatus is a photoelectric reading apparatus such as a digital camera, a barcode identifying device and the like. The reading apparatus is installed on or connected to the mobile terminal device. The reading apparatus may identify the encoded information on the information carrier, and may acquire a coded number of the advertising information (advertising ID). The reading apparatus sends the coded number of the advertising information to the mobile terminal.

The mobile terminal is capable of communication, and sends the coded number of the advertising information (advertising ID) received from the reading apparatus to the advertising server via the network by the function of information communication (for example, browser function) on the mobile terminal. The mobile terminal comprises the apparatus for acquiring the location information of the mobile terminal and the apparatus for acquiring the time at which the mobile terminal sends the advertising information. The mobile terminal may have the location information acquiring function for acquiring the location information of the mobile terminal, so as to send to the advertising server the location information and the advertising information at the same time. Meanwhile, the time when the mobile terminal apparatus sends the advertising information and the location information is also sent to the advertising server.

The present invention provides an advertising server, which comprises: a storing apparatus for storing the advertising information, the advertisement content, the location information and the sending time information of the mobile terminal; an analyzing apparatus for performing statistics and analysis on the advertising information, the location information and the time information, and for sending the statistic and analysis results to the advertiser terminal according to a request of the advertiser terminal; and a matching apparatus for conditionally combining and matching the received advertising information, the location information and the time information to create one or more storage records (for example, URL of a website) in the server, and for sending the one or more storage records to the mobile terminal according to a request of the mobile terminal.

Additionally, the system for collecting advertisement information and for analyzing may also comprise an advertiser terminal, which is to be used by an advertiser, and is connected with the advertising server via the network. The advertiser terminal may interact with the advertising server, and may acquire real-time, dynamic and continuous statistic and analysis results from the advertising server via the network.

### EXAMPLE 1

In a system for collecting advertisement information and for analyzing in accordance with example 1 of the present invention, barcode is employed as the information carrier.

FIG. 2 lists some patterns of one-dimensional barcode and two-dimensional barcode. A barcode is formed of monochrome images which are encodable and automatically identifiable. It may be encoded by computer and can be made on a barcode printing device, or it may be generated by outputting electronic files to a lithographing and typesetting device or a film outputting device, and being lithographed and printed in connection with advertisement. The image data of a barcode may be read by a photoelectric sensing element such as CCD or CMOS, and may be interpreted to the previously encoded data by a decoding apparatus.

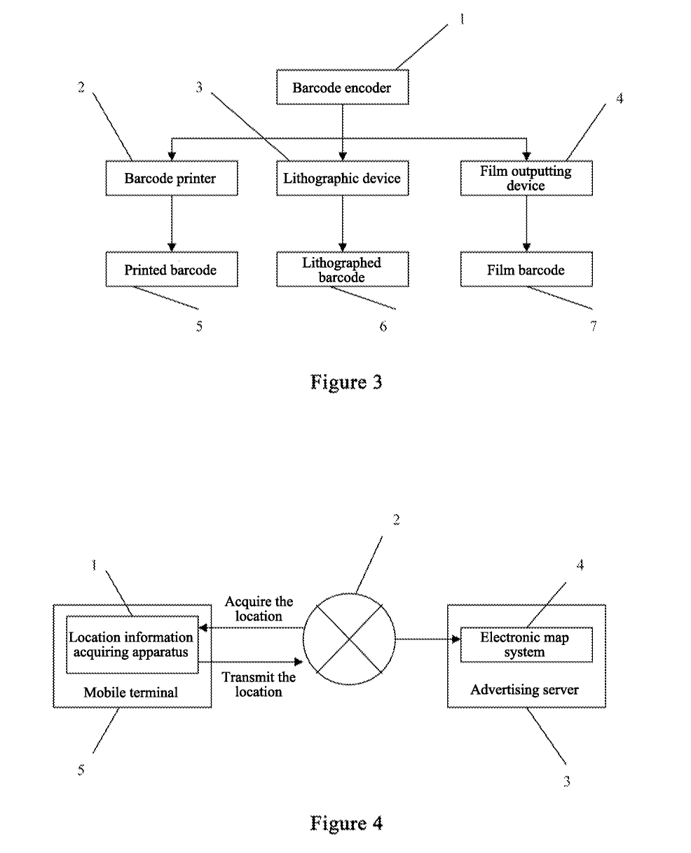

FIG. 3 is a block diagram of a writing apparatus. Advertising information, for example, advertising media, distribution region, advertisement content, advertiser and the like, is input into a barcode encoder (1) by computer. The barcode encoder brings the advertising information into correspondence with a piece of or a set of coding information, and transforms the coding information into barcode image information. The barcode image information is input into a barcode printer (2), and is printed as a printed barcode (5); alternatively, the barcode image information is input into a lithographic device (3), and is typeset and lithographed or printed with advertisement text and graphic as a lithographed barcode (6), which is used for lithographed advertisements and outdoor printed advertisements; or alternatively, the barcode image information is input into a film outputting device (4), and is output on films with advertisement text and graphic as a film barcode (7), which is used for outdoor lamp box advertisements.

FIG. 4 is a schematic diagram of the principle of the location acquiring apparatus. The location acquiring apparatus (1) in the mobile terminal (5) sends to the network (2) a location query request based on user's demand or system triggering. The network acquires location coordinate information of the mobile terminal by its own or networked locating system such as GPS, and sends the location coordinate information to the mobile terminal. The mobile terminal apparatus acquires the location coordinate information, and sends the location coordinate information in combination with the advertising information via the network (2) to the advertising server (3). The advertising server (3) has an electronic map system (4), and acquires the real location information of the mobile terminal by matching the location coordinate information with data in the electronic may system.

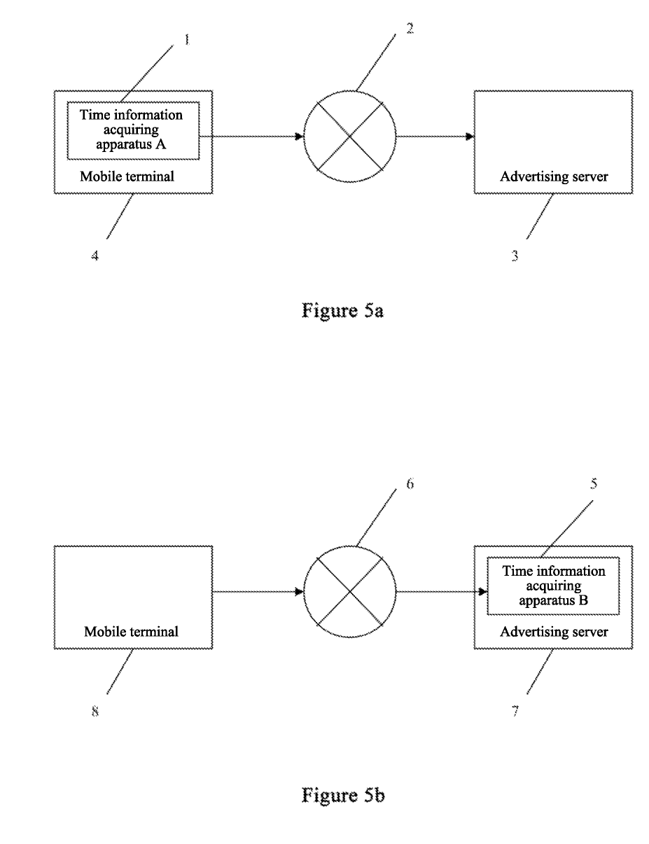

FIG. 5a is a schematic diagram of the principle of the time acquiring apparatus. The time acquiring apparatus A (1) acquires clocking information of the mobile terminal when the advertising information is sent. The information is sent together with the advertising information to the advertising server (3) via the network (2), and the advertising server (3) combines the time information with the advertising information and the location information, and stores the combined information.

FIG. 5b is a schematic diagram of the principle of another embodiment of the time acquiring apparatus. In this embodiment, the time acquiring apparatus B (5) is set in the advertising server (7), and acquires clocking information of the advertising server (7) when the advertising information is received from the mobile terminal (8) via the network (6). The advertising server (7) combines the time information with the advertising information and the location information, and stores the combined information.

Example 1 is that an advertiser (for example, IBM) advertises for a certain product (for example, notebook computer) on a newspaper (for example, Beijing Evening Post) with lithographed advertisements, and performs advertising monitoring and analyzing by barcodes carrying advertising information. An advertisement information combination of, for example, “IBM, Beijing, Beijing Evening Post, notebook computer category” is input by the writing apparatus in FIG. 3 into the barcode encoder (1), and corresponds to one advertising ID or a set of advertising IDs. The advertising ID is transformed into barcode image information. The barcode image information is input into the lithographic device, and is typeset and lithographed together with advertisements as newspaper advertisements with barcodes.

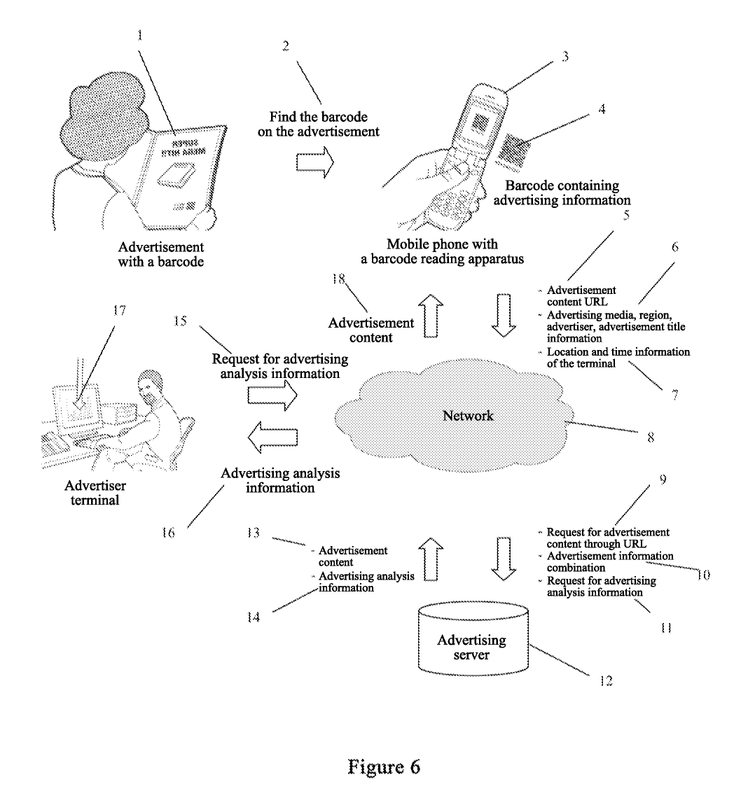

FIG. 6 schematically shows the flow of example 1. A consumer sees an advertisement (1) with a barcode for a certain product (for example, notebook computer) owned by a certain advertiser (for example, IBM) on a certain newspaper (for example, Beijing Evening Post), and reads the barcode (4) which contains the advertising ID by a mobile phone (3) with a barcode reading apparatus. The barcode image information is read through photoelectric sensing element such as CCD or CMOS in the barcode reading apparatus, and is decoded into the advertising ID which was encoded. The stored advertising information to which the advertising ID corresponds includes advertisement content URL (5), media, region, advertiser, and advertisement title information (6) in the advertising server. An apparatus such as the browser in the mobile phone reads the decoded advertisement content URL, which may be a complete URL decoded from the advertising ID information, or may be a new URL generated by combining a preset URL in the browser and a portion of the data in the advertising ID, the later of which may reduce the data amount in the advertising ID to facilitate the reading of the barcode, at the same time improve the security and reliability of advertising monitoring and facilitate the barcodes management, because only designated URL may be entered through barcode identification due to directive portions of URL built-in in the browser and other URLs may be turned to through this URL. The mobile phone has communication function, and sends the advertising ID in connection with the location, time information (7) of the mobile terminal to an advertising server (12) via a network (8).

The advertising server (12) receives a request for advertisement content (9) through URL from the mobile phone via the network (8), and sends advertisement content (18) to the mobile phone (3) via the network (8). Additionally, the advertising server (12) match the advertising ID with the advertising information in a memory, and obtain an advertisement information combination (for example, IBM, Beijing, Beijing Evening Post, notebook computer) corresponding to the barcode and stores the advertisement information combination; furthermore, the location information and the sending time information of the mobile terminal are also stored. The advertising server performs statistics and analysis on the stored information, and sends advertising analysis information (16) to an advertiser terminal (17) in real time, according to a request for advertising analysis information (15) from the advertiser terminal (17).

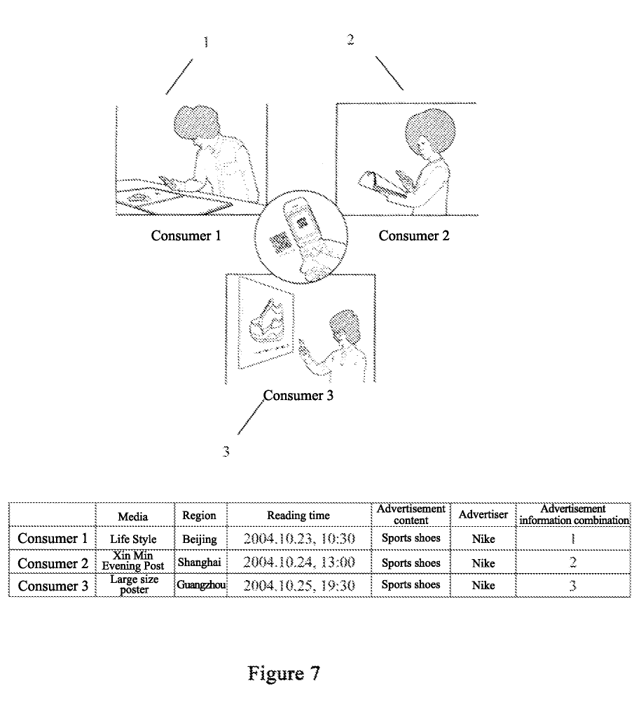

FIG. 7 is an instance for advertising on three media in three regions and performing advertising monitoring and analyzing. A consumer 1 reads a barcode for sports shoes advertisement of Nike company from Life Style in Beijing at 10:30, Oct. 23, 2004, so the barcode and the information of the mobile terminal combine as: “Region: Beijing, Media: Life Style, Read time: 10:30, 2004.10.23, Advertisement content: Sports shoes, Advertiser: Nike”, and a storage record is formed in an advertising server as an advertisement information combination 1; a consumer 2 reads a barcode for sports shoes advertisement of Nike company from Xin Min Evening Post in Shanghai at 13:00, Oct. 24, 2004, so the barcode and the information of the mobile terminal combine as: “Region: Shanghai, Media: Xin Min Evening Post, Read time: 13:00, 2004.10.24, Advertisement content: Sports shoes, Advertiser: Nike”, and a storage record is formed in the advertising server as an advertisement information combination 2; similarly, a consumer 3 reads a barcode for sports shoes advertisement of Nike company from a large size poster in Guangzhou at 19:30, Oct. 25, 2004, so the barcode and the information of the mobile terminal combine as: “Region: Guangzhou, Media: large size poster, Read time: 19:30, 2004.10.25, Advertisement content: Sports shoes, Advertiser: Nike”, and a storage record is formed in the advertising server as an advertisement information combination 3. The encoding flow of barcode information is as shown in FIG. 3, and the reading and analyzing flow is as shown in FIG. 6, which are not repeated herein.

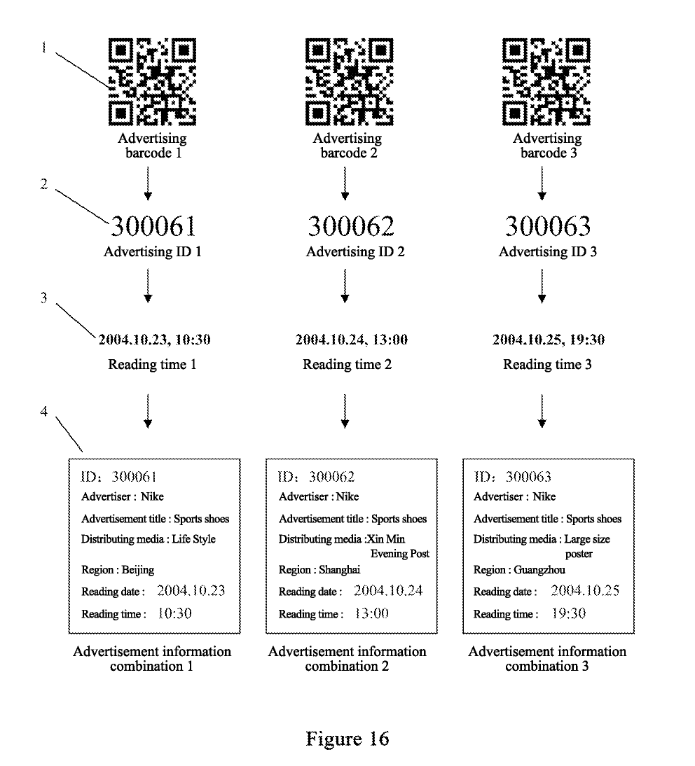

In the instance of FIG. 7, a matching flow of an advertiser ID in a barcode and an advertisement information combination stored by an advertising server is shown. Referring to FIG. 16, an advertising ID (2) (for example, the advertising ID is 300061) has been encoded into an advertising barcode (1), and the reading time (3) sent to the advertising server after a mobile terminal reads the advertising barcode is recorded by the advertising server. The advertising ID in the advertising barcode is sent to the advertising server by the mobile terminal apparatus via a network, and is matched with stored advertising IDs in the advertising server. An advertisement information combination (4) is fetched from the advertising server according to the matched advertising ID, which is “Advertiser: Nike, Advertisement title: Sports shoes, Media: Life Style, Region: Beijing, Reading date: 2004.10.23, Reading time: 10:30” in this instance.

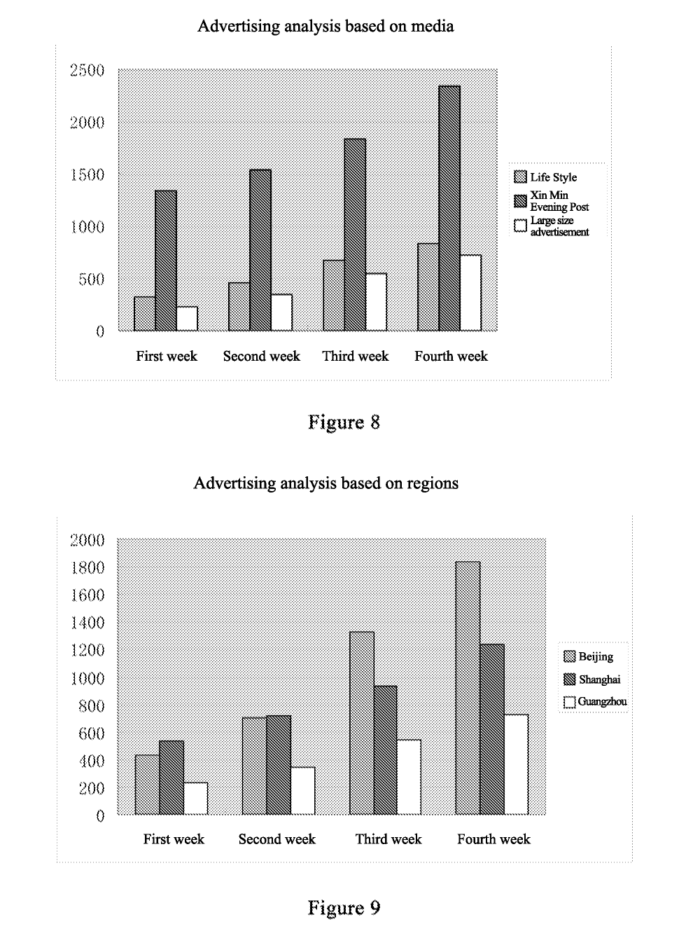

FIG. 8 shows an advertising analysis report with respect to media from an advertiser terminal, according to the instance in FIG. 7, wherein the horizontal axis represents time, which is in the unit of weeks in this instance; and the vertical axis represents read times of advertising barcodes, i.e., feedback times of users to the advertisements. This instance shows an analysis result of 4 weeks. It can be seen from the chart that users' feedbacks increases as time passes, because more consumers may pay interests to advertisements as the advertisements present in high frequency and may take further actions. Additionally, it can be seen from the chart that the advertisement feedbacks from Xin Min Evening Post is obviously higher than those from another two media, which means either the circulation is larger or the readers thereof is more suitable for advertising, or the both.

FIG. 9 shows an advertising analysis report with respect to regions from an advertiser terminal, according to the instance in FIG. 7, wherein the horizontal axis represents time, which is in the unit of weeks in this instance; and the vertical axis represents read times of advertising barcodes, i.e., feedback times of users to the advertisements. This instance shows an analysis result of 4 weeks. It can be seen from the chart that the increase rate of advertisement feedbacks as time passes in Beijing is obviously higher than those in another two regions, which means the advertisement content is more suitable for consumers in Beijing and makes consumers take more actions.

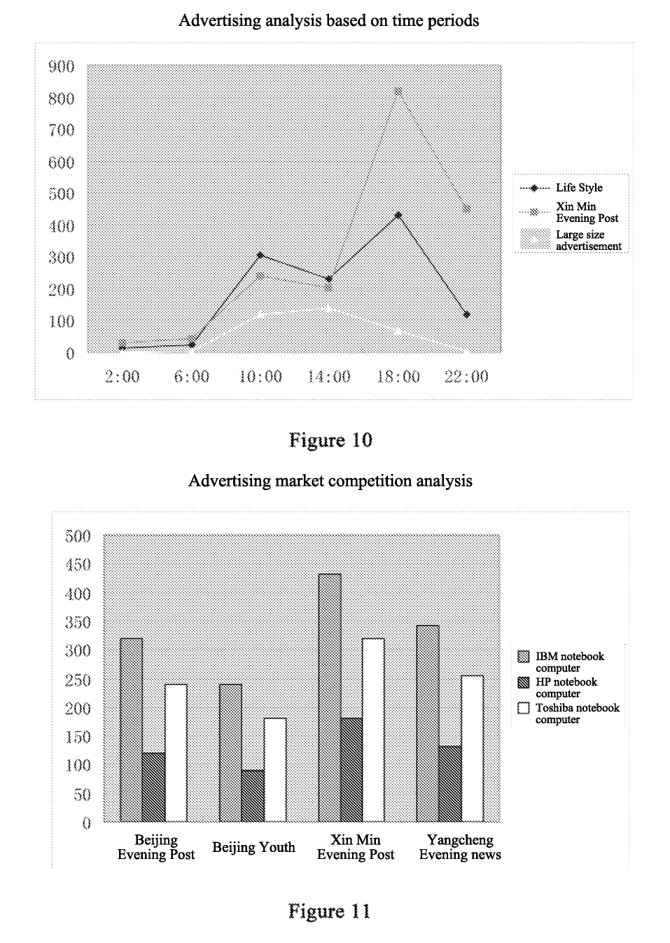

FIG. 10 shows an advertising analysis report with respect to time periods from an advertiser terminal, according to the instance in FIG. 7, wherein the horizontal axis represents time, which is in the unit of hours in this instance; and the vertical axis represents read times of advertising barcodes, i.e., feedback times of users to the advertisements. This instance shows an analysis result of a whole day for 24 hours. It can be seen from the chart that users' feedbacks from Xin Min Evening Post peak at about 19:00 pm, whereas those of Life Style peak at both 10:00 am and 19:00 pm, meanwhile feedbacks of large size poster as outdoor advertisement mainly converge between 8:00 am to 18:00 pm in the daytime. This substantially shows features of different media, and advertisers may make sales promotions of more pertinence by using these features. For example, sales promotion advertisements of pubs are suitable for being published on media like Xin Min Evening Post, because 19:00 pm is the peak of reading, and consumers may take actions immediately after reading the advertisements.

FIG. 11 shows an analysis of advertising market competition for three advertisements of same product category on four media. Wherein the horizontal axis represents different media, and the vertical axis represents read times of advertising barcodes, i.e., feedback times of users to the advertisements. This figure is based on once publication of each of the three advertisements on each of the four media. It can be seen from the chart that the feedbacks to IBM notebook computer is obviously higher than those to another two products, which means either the advertising originality for IBM is good, or product cognition degree to IBM is high, or the both. The advertiser may adjust the advertising scheme according to the analysis result, by either modifying the originality or making new media planning.

### EXAMPLE 2

Example 2 is to add monitoring and analyzing for a series of operations of a mobile phone, which begin with acquiring advertisement content through a URL from a network, based on example 1. As such, actions and transaction intents of consumers may be analyzed, and the analysis result may be sent to the advertiser by an advertiser terminal, and then further information may be provided to consumers according to the analysis.

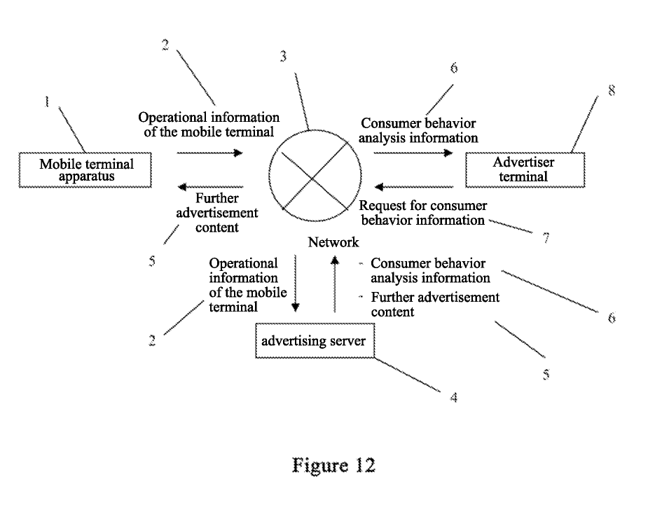

FIG. 12 is a block diagram of adding monitoring and analyzing for a series of operations of a mobile phone, which begin with acquiring advertisement content through a URL from a network, based on example 1. Beginning from the time at which the mobile terminal (1) acquires advertisement content through the URL from the network (3), mobile terminal operation information (2) of the mobile terminal is sent to an advertising server (4) via the network (3), and is stored therein. The mobile terminal operation information may be combined with the advertising information, mobile terminal location information and time information as described in the example 1 as a consumer information combination, and the advertising server performs statistics and analysis on the consumer information combination to generate consumer behavior analysis information (6), which is sent via the network (3) to an advertiser terminal (8) in response to a request for consumer behavior information (7) sent out by the advertiser terminal (8); additionally, the advertising server matches the consumer information combination with stored further advertisement content (5). The matched further advertisement content (5) is transmitted to the mobile terminal (1) via the network (3), as such advertisement sales promotions of pertinence to consumers are achieved.

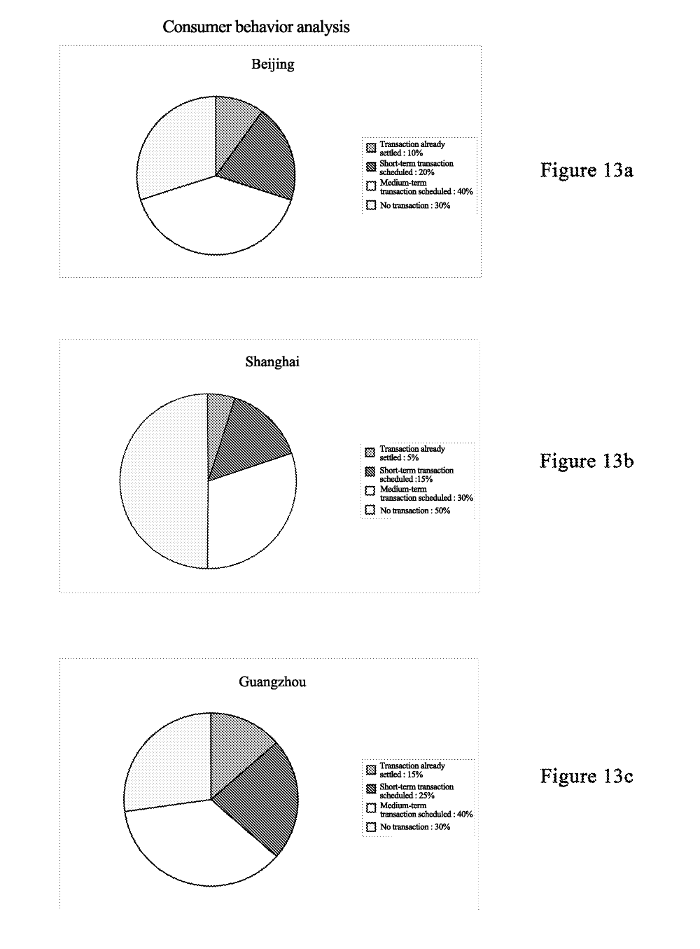

FIGS. 13a, 13b and 13c show consumer behavior analysis for three regions based on example 2. The advertising server in example 2 performs statistics and analysis on consumer information combinations of the three regions of Beijing, Shanghai and Guangzhou, and matches the result with four stored consumer behavior patterns, which are transaction already settled, short-term transaction scheduled, medium-term transaction scheduled and no transaction, respectively. The matched information is stored, and is sent to an advertiser terminal via a network. It can be seen from FIGS. 13a, 13b and 13c that consuming behaviors of consumers in Guangzhou are the most active, represented as the percentage of consumers who have transaction already settled and have short-term transaction scheduled is the highest; whereas consuming behaviors of consumers in Shanghai are the most negative, represented as the percentage of consumers who have transaction already settled and have short-term transaction scheduled is the lowest.

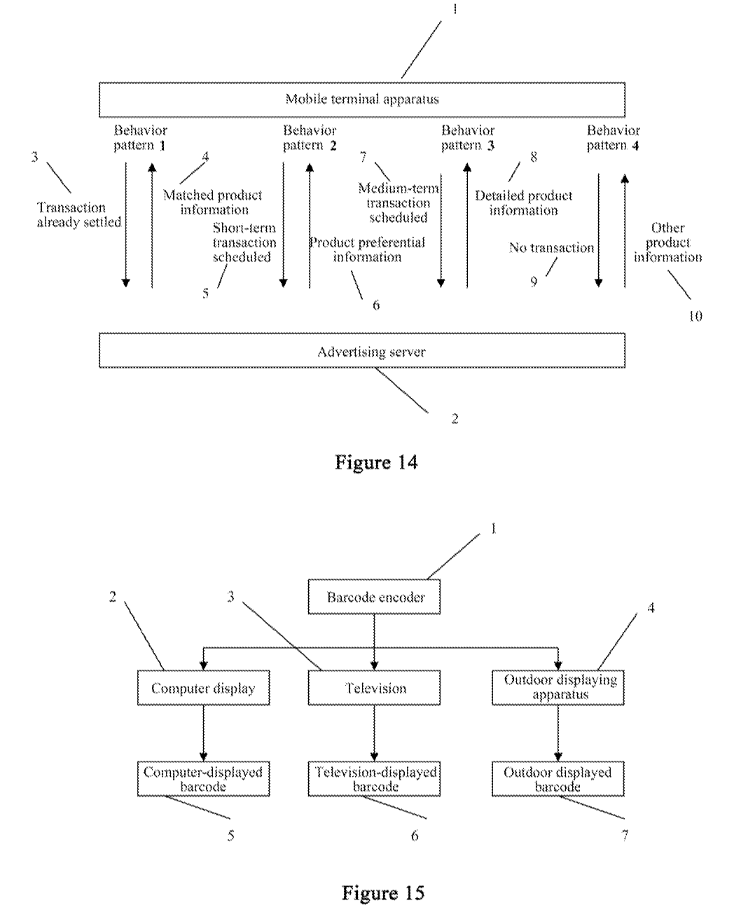

FIG. 14 is a schematic of classifying consumer behavior patterns and feeding back information respectively based on example 2. The consumer behaviors are classified into four patterns in the figure. In behavior pattern 1, the operation of a mobile terminal apparatus is matched with transaction already settled (3) by an advertising server (2), so the advertising server (2) sends matched product information (4) to the mobile terminal apparatus (1); in behavior pattern 2, the operation of the mobile terminal apparatus is matched with short-term transaction scheduled (3) by the advertising server (2), so the advertising server (2) sends product preferential information (6) to the mobile terminal apparatus (1); in behavior pattern 3, the operation of the mobile terminal apparatus is matched with medium-term transaction scheduled (7) by the advertising server (2), so the advertising server (2) sends detailed product information (8) to the mobile terminal apparatus (1); and in behavior pattern 4, the operation of the mobile terminal apparatus is matched with no transaction (9) by the advertising server (2), so the advertising server (2) sends other product information (10) to the mobile terminal apparatus (1).

### EXAMPLE 3

Example 3 is to change the carrying medium for advertising barcodes (i.e., advertising media) in example 1 into display terminals such CRT, LDC, PDP, projector and the like (including television sets).

FIG. 15 shows a block diagram of a writing apparatus based on example 3. Advertising information, for example, advertising media, distribution region, advertisement content, advertiser and the like, is input into a barcode encoder (1) by computer. The barcode encoder brings the advertising information into correspondence with one or a set of advertising IDs, and transforms the advertising ID into barcode image information. The barcode image information is input into a computer display (2), wherein the barcode is computer-displayed barcode (5) for being displayed together with advertisement or content on the computer; or the barcode image information is input into a television (3), wherein the barcode is television-displayed barcode (6) for being displayed together with television advertisement or content; or the barcode image information is input into an outdoor displaying apparatus (4), wherein the barcode is outdoor displayed barcode (7) for being displayed together with outdoor display advertisement or content.

Other apparatus in example 3, for example, the reading apparatus, the location acquiring apparatus, the time acquiring apparatus, the mobile terminal apparatus, the advertising server, the advertiser terminal and so on, are the same as those in example 1. The flow and analyzing method for advertising information is also the same as those of example 1. Additionally, the advertising barcode carrying medium and the writing apparatus in example 3 are also suitable for example 2.

1-17. (canceled)

18. A system, comprising:
an information carrier for carrying an advertising ID corresponding to a set of advertising information stored in an advertising server;
a mobile terminal having a reading apparatus for reading the advertising ID;
a location acquiring apparatus for acquiring location information of the mobile terminal;
a time acquiring apparatus for acquiring time information of the mobile terminal; and
an analyzing apparatus for performing advertising monitoring by real-time analyzing based on the set of advertising information, the location information and the time information,
wherein the mobile terminal, the location acquiring apparatus, the time acquiring apparatus and the analyzing apparatus are coupled in a network.

19. The system as claimed in claim 18, wherein the system further comprises a writing apparatus for compiling the advertising ID according to the set of advertising information, and writing the advertising ID into the information carrier.

20. The system as claimed in claim 18, wherein the advertising server receives the advertising ID, the location information and the time information, and the analyzing apparatus is set within the advertising server.

21. The system as claimed in claim 20, wherein the advertising server further comprises a matching apparatus for conditionally combining and matching the set of advertising information corresponding to the advertising ID, the location information and the time information to create a storage record in the advertising server, and for sending the storage record to the mobile terminal in response to a request of the mobile terminal.

22. The system as claimed in claim 20, wherein the advertising server further stores, monitors and analyzes a series of operations of the mobile terminal.

23. The system as claimed in claim 18, wherein the system further comprises an advertiser terminal for receiving analysis report from the analyzing apparatus via the network by sending out a request for analysis result.

24. The system as claimed in claim 18, wherein the set of advertising information comprises at least one of advertising medium, advertising region, advertiser, advertisement-related content or index and a combination thereof.

25. The system as claimed in claim 18, wherein the information carrier is formed of encodable and automatically identifiable image.

26. The system as claimed in claim 18, wherein the carrying medium of the information carrier comprises at least one of paper, plastic, chinaware, wood, CRT, LCD, PDP, outdoor display and a combination thereof.

27. The system as claimed in claim 18, wherein the network comprises at least one of public network, private network, wireless local area network and a combination thereof.

28. The system as claimed in claim 20, wherein the transmitting format between the mobile terminal and the advertising server may be in the form of URL, email, SMS, MMS, WAP and a combination thereof.

29. The system as claimed in claim 18, wherein the reading apparatus is a barcode reading apparatus that is installed on or wirelessly connected to the mobile terminal.

30. The system as claimed in claim 18, wherein the mobile terminal is a mobile telephone or a PDA with photographic function.

31. A method, comprising:
carrying an advertising ID on an information carrier, the advertising ID corresponding to a set of advertising information stored in an advertising server;
reading the advertising ID by an reading apparatus on a mobile terminal;
acquiring location and time information of the mobile terminal by a location acquiring apparatus and a time acquiring apparatus; and
performing advertising monitoring by real-time analyzing based on the set of advertising information, the location information and the time information by an analyzing apparatus.

32. The method as claimed in claim 31, wherein the operation of carrying an advertising ID on an information carrier further comprises compiling the advertising ID according to the set of advertising information, and writing the advertising ID into the information carrier by a writing apparatus.

33. The method as claimed in claim 31, further comprising conditionally combining and matching the set of advertising information corresponding to the advertising ID, the location information and the time information to create a storage record, and sending the storage record to the mobile terminal in response to a request of the mobile terminal.

34. The method as claimed in claim 33, wherein performing advertising monitoring comprises performing analysis on the created storage record by the analyzing apparatus.

35. The method as claimed in claim 34, wherein performing advertising monitoring comprises performing consumer behavior monitoring based on the result of the analysis on the created storage record.

36. The method as claimed in claim 31, wherein the operation of acquiring the location information of the mobile phone further comprises:
sending out to a location query request based on user's demand or system triggering;
acquiring location coordinate information of the mobile terminal by its own or networked locating system comprising GPS;
sending the location coordinate information to an advertising server; and
acquiring the real location information of the mobile terminal by matching the location coordinate information with data in an electronic map system within the advertising server.
